(19) United States
(12) Patent Application Publication
(10) Pub. No.: US 2015/0073932 A1
(43) Pub. Date: Mar. 12, 2015

(54) Strength Based Modeling For Recommendation System

(71) Applicant: Microsoft Corporation, Redmond, WA (US)

(72) Inventors: Nir Nice, Kfar Veradim (IL); Noam Koenigstein, Tel Aviv (IL); Ulrich Paquet, Cambridge (GB); Shahar Keren, Tel Aviv (IL); Daniel Sitton, Tel Aviv (IL)

(73) Assignee: Microsoft Corporation, Redmond, WA (US)

(21) Appl. No.: 14/023,490

(22) Filed: Sep. 11, 2013

(51) Int. Cl. G06Q 30/06

(52) U.S. Cl. CPC G06Q 30/0631
USPC 705/26.7

(57) ABSTRACT

Example apparatus and methods provide a recommendation to a user about a product they may wish to consider purchasing. One method produces a single indication concerning a relationship between a user and an item with which the user has interacted. The single indication identifies whether the user likes the item and the degree to which the user likes the item. The single indication is independent of user signals processed to compute the single indication. The single indication is produced by a signal deriver that is loosely coupled to a model of users and items. The model may be a matrix upon which matrix factorization can be performed. Although matrix factorization is performed, it is performed on vectors whose elements are independent of the signals processed by the signal deriver. Since users may have different preferences at different times, the degree to which the user likes the item may be manipulated.

### BACKGROUND

Conventional recommendation systems make recommendations about matches between users (e.g., shoppers) and items (e.g., books, videos, games) based on user interests, preferences, history, and other factors. For example, if a user has previously acquired (e.g., purchased, rented, borrowed) a set of items, then a recommendation system may identify similar items and recommend them to the user based on the user's own actions. Conventional recommendation systems may also determine similarities between users and make additional recommendations based on those similarities. For example, if users in a certain demographic and with similar acquisition histories and preferences have acquried a set of items, then a recommendation system may identify items and recommend them to a user based on the actions of other users.

Conventional recommendation systems may model user signals. User signals may be explicit or implicit. Explicit signals may include ratings giving to a product by a user. For example, a reader may give a five star rating to a first book by a first author and may give a one star rating to a second book by a second author. Additionally, the reader may “like” the first book on a social media site and “dislike” the second book on the social media site. A conventional recommendation system may model these explicit signals to determine which other books and authors to recommend and which to avoid. Implicit signals may include, for example, observed user behavior, acquisition history, browsing history, search patterns, the amount of time an item (e.g., video game) is played, the number of times an item is viewed, the percentage of a video watched, or other factors. A recommendation system may also model these implicit signals to determine which other items to recommend.

Conventional recommendation systems have modeled user signals by performing matrix factorization on a single large matrix in which data about the available signals is stored. However, when a matrix has rows and columns for N factors, N being an integer, data may only be available for M of the factors, M being an integer less than N. Matrix factorization may therefore be used on the available data to identify missing data. Once the matrix factorization has produced data for the missing signals, business logic may process the actual signals and predicted signals to make a recommendation. Conventional recommendation systems may characterize items and users as a function of vectors of factors inferred from user signals. A high correspondence between items and factors may lead to a recommendation. Matrix factorization models may map both users and items to a joint factor space and model user-item interactions as inner products in the joint factor space. An item may be associated with an item vector whose elements measure the extent to which the item possesses some factors. Similarly, a user may be associated with a user vector whose elements measure the extent of interest the user has in items that are high in corresponding factors. The dot product of the vectors may describe the interaction between the user and item and may be used by business logic to determine whether to make a recommendation.

Unfortunately, conventional recommendation systems face several challenges. For example, it may be difficult to determine the mapping of item factors and user factors. Even if the mapping is determined, whenever a new signal is added or removed, the mapping, model, and business logic may need to be changed to account for the added or removed signal. Additionally, as the number of signals grows, both the model and business logic may grow unacceptably complicated or cumbersome. When business logic becomes unacceptably complicated or cumbersome it may be difficult, if even possible at all, to verify that the business logic is producing valid or useful recommendations. The business logic may be unverifiable due, at least in part, to the fact that it inputs signals that are predicted by matrix factorization rather than relying on actual user signals.

### SUMMARY

This Summary is provided to introduce, in a simplified form, a selection of concepts that are further described below in the Detailed Description. This Summary is not intended to identify key features or essential features of the claimed subject matter, nor is it intended to be used to limit the scope of the claimed subject matter.

Example apparatus and methods use two loosely coupled components to produce a recommendation about an item (e.g., movie, game, book, article of clothing). A data store may store signals acquired about a user interaction with an item. An indication of whether the user likes the item may be computed from the signals. The indication is signal independent and the indication is computed as a function of an affinity hypothesis specific to the user or item. A confidence level is also computed for the indication. The confidence level is signal independent and is computed as function of a strength hypothesis specific to the user or item, The indication and confidence level are stored in a strength based model. The strength based model provides data (e.g., a set of indicators and confidence levels) from which predicted relationships between users and items can be computed. Electronic data that includes a recommendation concerning an item to acquire may be produced based, at least in part, on the predicted relationship.

In one example, a recommendation to a candidate user about a candidate item is produced. Producing the recommendation includes producing a first electronic data point or data points that describe a relationship between a first user and a first item. The relationship is defined in terms of an affinity value that identifies whether the first user likes the first item, and a confidence level associated with the affinity value. The affinity value and the confidence level are computed as a function of observed data about an interaction between the first user and the first item. Producing the recommendation also includes storing the first electronic data in a data structure (e.g., matrix) that stores relationships between users and items according to a strength based model. Producing the recommendation also includes producing the recommendation as a function of data stored in the data structure. The recommendation depends on a predicted affinity value for the candidate user for the candidate item.

### BRIEF DESCRIPTION OF THE DRAWINGS

The accompanying drawings illustrate various example apparatus, methods, and other embodiments described herein. It will be appreciated that the illustrated element boundaries (e.g., boxes, groups of boxes, or other shapes) in the figures represent one example of the boundaries. In some examples, one element may be designed as multiple elements or multiple elements may be designed as one element. In some examples, an element shown as an internal component of another element may be implemented as an external component and vice versa. Furthermore, elements may not be drawn to scale.

FIG. 1 illustrates creation of an example data structure.

FIG. 2 illustrates use of an example data structure.

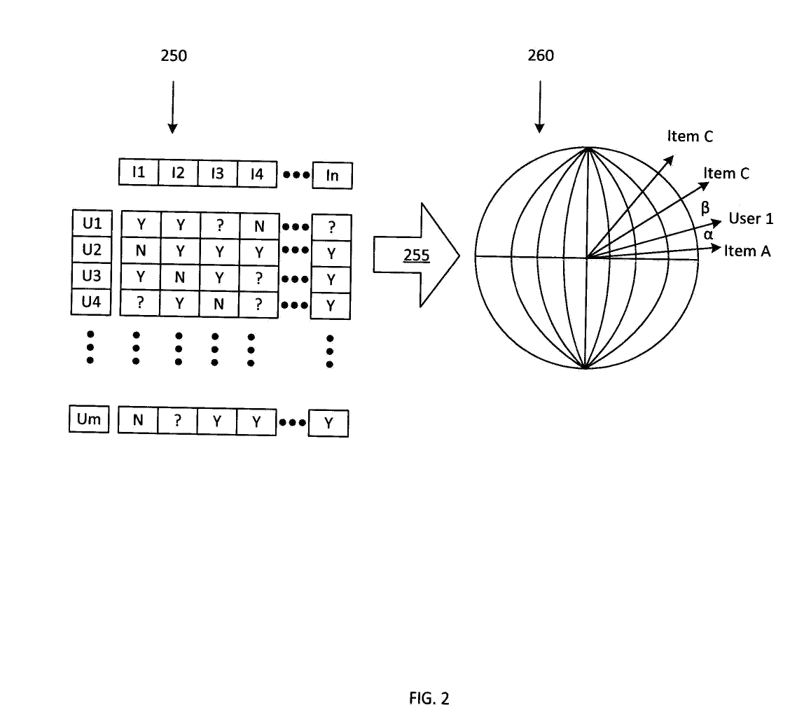

FIG. 3 illustrates an example method associated with strength based modeling for a recommendation system.

FIG. 4 illustrates an example method associated with strength based modeling for a recommendation system.

FIG. 5 illustrates an example apparatus associated with strength based modeling for a recommendation system.

FIG. 6 illustrates an example apparatus associated with strength based modeling for a recommendation system.

FIG. 7 illustrates an example cloud operating environment.

FIG. 8 is a system diagram depicting an exemplary mobile communication device configured to participate in strength based modeling for a recommendation system.

### DETAILED DESCRIPTION

Example apparatus and methods provide a recommendation system with two loosely coupled parts. The two loosely coupled parts communicate through a well-defined interface that uses a data structure produced by one part and used by the other part. The first part is responsible for signal derivation, which refers to understanding a relationship between a user and an item. Signals that are available are processed in light of certain affinity and strength hypotheses to make a determination about whether a user likes an item. Once the signal derivation determines whether a user likes an item, the first part may also produce a confidence level for the determination. The signal derivation may then produce electronic data that provides a single indication of the user:item relationship. The single indication may be, for example, a tuple of the form <user, item, likes?, strength>, where strength is the confidence level in the likes/does-not-like determination. In different embodiments different indications may be provided. Note that the indication is independent of the signals from which the indication was computed in that the indication does not include any of the signals from which the indication was computed.

Multiple indications may be stored in a data structure and then the data structure may be used by the second part. The data structure may store information about users, items, affinity, and strength. Therefore the data structure may support a strength based model for a recommendation system. The second part may use, for example, matrix factorization to compute a predicted relationship between a user and an item: The predicted relationship may be a likes/does-not-like relationship. Recommendations may then be made from the predicted relationship. The two parts are loosely coupled through their interfaces to the data structure.

Unlike conventional systems, the model from which predicted relationships are computed is independent of the user signals that were processed in the model. For example, the model is independent of both the type and number of observed signals. Additionally, the first part may now be verified. For example, the single indication produced by signal derivation may be presented to a user and feedback acquired from the user concerning the like/does-not-like determination and the confidence level in the like/does-not-like determination. The hypotheses that were used in signal derivation may then be adapted based on the feedback.

Example apparatus and methods may also account for different behaviors or conditions at different times or places. For example, a recency based model may increase the strength for items that were acquired (e.g., purchased, borrowed, rented) recently while it may decrease the strength for items that were acquired less recently. Additionally, a time based model may give higher strength to items that were consumed during a specific time window (e.g., morning, weekend, during Super Bowl). More generally, time and other parameters may be considered to influence the strength associated with the likes/does-not-like relationship.

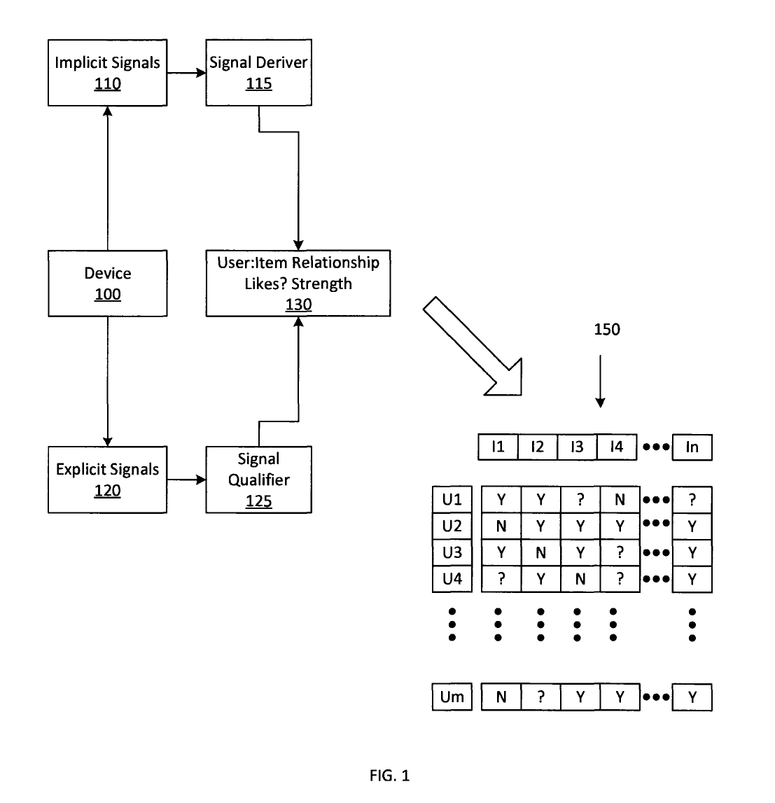

FIG. 1 illustrates a device 100 from which implicit signals 110 or explicit signals 120 may be acquired. While a single device 100 is illustrated, signals may be acquired from multiple devices. Device 100 may be, for example, a game console through which a user acquires and plays a video game. The user may also use the device 100 to rate the video game, to blog about the video game, or to perform other actions.

The explicit signals 120 may be, for example, subjective ratings generated by a user. For example, a user may give a first game a 1 out of 10 rating to indicate they do not like the first game but may give a 9 out of 10 rating to a second game to indicate they like a second game. The implicit signals 110 may be, for example, objective data generated from user interactions with the game. The objective data may include, for example, how many times the user has played the game, how long it's been since the user last played the game, how frequently the user plays the game, how frequently the user plays other games, how much the user has paid for add-ons to the game, or other data. A user may determine which implicit signals, if any, to allow to be reported.

The explicit signals 120 may be processed by a signal qualifier 125 and the implicit signals may be processed by a signal deriver 115. While two separate apparatus are illustrated, in one embodiment the explicit signals 120 and the implicit signals 110 may be processed by one or more apparatus or processes that work to understand the likes/does-not-like relationship. Different users may produce different data. Therefore, in one embodiment, signal derivation may be customized on a per user basis. Different items (e.g., video games, videos, books, clothing) may also produce different data. Therefore, in one embodiment, signal derivation may be customized on a per item basis. A user may exhibit different tendencies and preferences at different times, in different locations, and under different circumstances for different items or types of items. Therefore, in one embodiment, signal derivation may be customized for a user and an item under different circumstances.

The signal derivation process will produce a single indication 130. The single indication 130 describes the user:item relationship using a likes/does-not-like indicator and a strength or confidence indicator. The strength indicator provides information about the certainty or confidence associated with the likes/does-not-like indicator.

Single indicators may be collected into a data structure 150. In one embodiment the data structure 150 is a matrix that stores a strength based model. The matrix may store information about whether a user likes an item, about whether a user does not like an item, and about the confidence level in the likes/does-not-like relationship. The matrix may also store an indication that no information is available for a particular user for a particular item. In data structure 150, a Y represents that a user likes an item, an N represents that a user does not like an item, and a ? indicates that information for that user for that item is unavailable. Example apparatus and methods may seek to fill in the missing information for a user and item. For example, based on the other indications in the data structure 150, example apparatus and methods may try to predict a relationship for user U1 and item I3. The relationship may be predicted from other data in the data structure 150.

Figure two illustrates a data structure 250 that is being used to predict a relationship for a user and an item. For example, data structure 250 does not have information about a likes/does-not-like relationship for user U1 and item I3. Example apparatus and methods may perform matrix factorization at 255 to facilitate understanding relationships between users and items. Matrix factorization may identify similarities between users or items and then predict the likes/does-not-like relationship based on those identified similarities. Graphic 260 illustrates vectors for User 1 and Item A, Item B, and Item C. Information about a relationship between User 1 and Item A may inform a decision about User 1 and Item B.

Similarities may depend on the time of day, location, devices available, or other factors. Two users from two separate demographics may be more similar at certain times and less similar at other times. For example, a blue collar worker who lives in an apartment and a white collar worker who works in an office may be from very different demographics and may have exhibited very different likes and dislikes in most aspects of their daily lives. However, under certain conditions, the two users may be very similar. For example, if both users are on public transportation headed to a sports event, for the duration of the ride the users may be very similar. Thus, example apparatus and methods may account for time, location, events in progress or pending, and other attributes when determining similarity.

Some portions of the detailed descriptions that follow are presented in terms of algorithms and symbolic representations of operations on data bits within a memory. These algorithmic descriptions and representations are used by those skilled in the art to convey the substance of their work to others. An algorithm is considered to be a sequence of operations that produce a result. The operations may include creating and manipulating physical quantities that may take the form of electronic values. Creating or manipulating a physical quantity in the form of an electronic value produces a concrete, tangible, useful, real-world result.

It has proven convenient at times, principally for reasons of common usage, to refer to these signals as bits, values, elements, symbols, characters, terms, numbers, distributions, and other terms. It should be borne in mind, however, that these and similar terms are to be associated with the appropriate physical quantities and are merely convenient labels applied to these quantities. Unless specifically stated otherwise, it is appreciated that throughout the description, terms including processing, computing, and determining, refer to actions and processes of a computer system, logic, processor, system-on-a-chip (SoC), or similar electronic device that manipulates and transforms data represented as physical quantities (e.g., electronic values).

Example methods may be better appreciated with reference to flow diagrams. For simplicity, the illustrated methodologies are shown and described as a series of blocks. However, the methodologies may not be limited by the order of the blocks because, in some embodiments, the blocks may occur in different orders than shown and described. Moreover, fewer than all the illustrated blocks may be required to implement an example methodology. Blocks may be combined or separated into multiple components. Furthermore, additional or alternative methodologies can employ additional, not illustrated blocks.

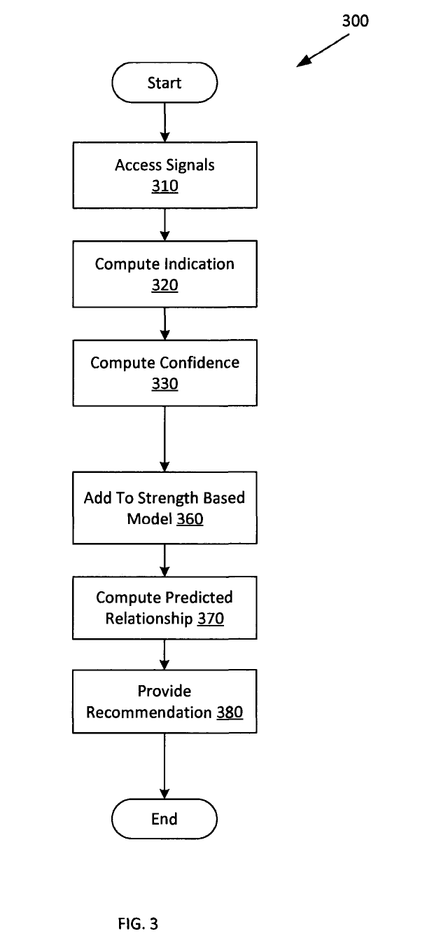

FIG. 3 illustrates an example method 300 associated with strength based modeling for a recommendation system. Method 300 may include, at 310, accessing a data store that stores signals acquired about a user interaction with an item. The signals may include subjective information provided by the user and objective information acquired about the user interaction with the item. Accessing the data store may include opening a file, opening a table, reading a file, reading from a table, receiving data through a pipe or socket, receiving information through a remote procedure call, receiving the address of a memory, or other action. The subjective information may include data generated by the user about the item. For example, a user may click a “like” button on a social media site, may post a positive review on a blog, or other action. The objective information may report on user interactions with an item. For example, the objective information may report when a user bought an ebook, when the user started reading the ebook, how long the user spent reading the ebook, and when the user finished the ebook.

Method 300 may also include, at 320, computing an indication of whether the user likes the item from the signals. The indication may be, for example, a binary yes/no value. Since the indication does not include any of the explicit signals or implicit signals, the indication is signal independent. In one embodiment, the indication may be computed as a function of an affinity hypothesis specific to the user or item. An affinity hypothesis may be, for example, a set of weights and operations (e.g., addition, multiplication, log) to apply to the available signals. Different users may have different hypotheses. Similarly, different items may have different hypotheses. Initially, the hypotheses may be reasoned estimates about how to compute the indication. Over time the hypotheses may change based on feedback received from the user.

Method 300 may also include, at 330, computing a confidence level for the indication from the signals. Like the indication, the confidence level is signal independent. The confidence level may be computed as a function of a strength hypothesis specific to the user or item. Like the affinity hypothesis, the strength hypothesis may include a set of weights and operations to apply to the available signals.

Once the affinity value and confidence level have been computed, method 300 may also include, at 360, storing the indication and confidence level in a strength based model. Storing the indication and confidence level in the strength based model facilitates decoupling similarity calculations and product predictions from the observed signals. Thus, the methods and apparatus used to compute the predicted relationship and to provide recommendations may not have to be reworked when a new signal is added to the observed signals, when an existing signal is removed from the observed signals, or when a hypothesis for calculating the affinity value or confidence level changes.

Method 300 may also include, at 370, computing a predicted relationship between the user and a second different item. While a relationship between the user and a second different item is described, method 300 may compute predicted relationships for different users and different items. The predicted relationship may be computed from a set of indicators and confidence levels stored in the strength based model. The indicators and confidence levels may be associated with the user for which the indication was computed at 320 and from which the confidence level was computed at 330. The indicators and confidence levels may also be associated with other users and other items. When the indicators and confidence levels are stored in a matrix, computing the predicted relationship may include performing matrix factorization on vectors formed from data in the strength based model. Since the indication and confidence levels are independent of the observed signals, elements of the vectors are also independent from the observed signals.

Method 300 may also include, at 380, selectively providing to the user an electronic data that includes a recommendation concerning the second item. While a single recommendation is described, in different examples multiple recommendations or a list of recommendations may be provided. Providing the electronic data may include, for example, displaying information on a screen, writing information to a memory, sending an object to a device, generating an interrupt, or other action performed in or by a computer. The recommendation is based, at least in part, on the predicted relationship.

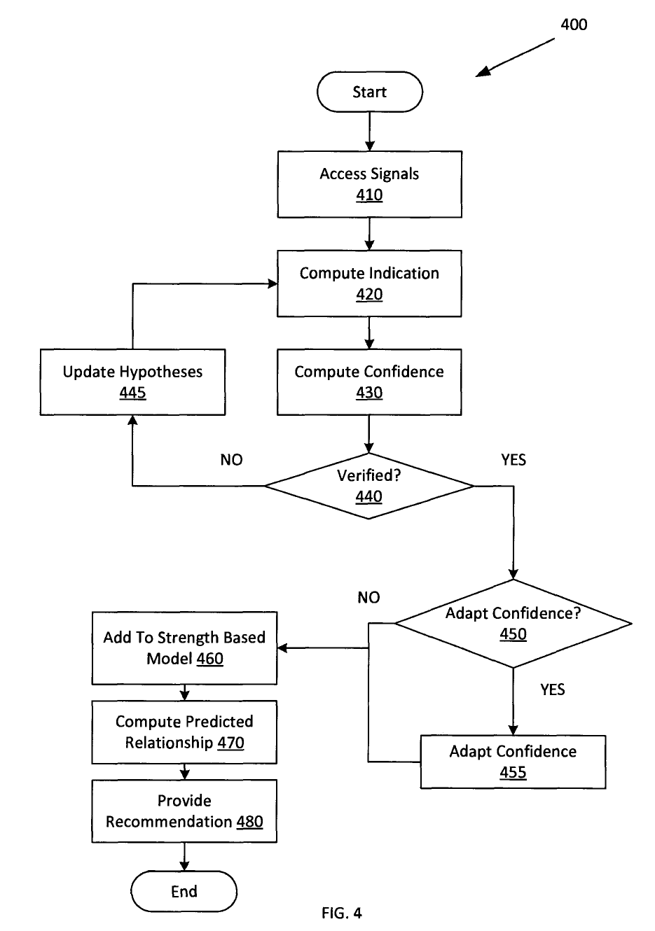

FIG. 4 illustrates an example method 400 associated with strength based modeling for a recommendation system. Method 400 includes several actions similar to those described in connection with method 300 (FIG. 3). For example, method 400 includes accessing signals at 410, computing an indication at 420, computing a confidence at 430, adding an indication to a strength based model at 460, computing a predicted relationship at 470, and providing a recommendation at 480. However, method 400 also includes additional actions.

For example, method 400 includes, at 440, making a determination of whether the indication has been verified. In one example, the indication may be verified by presenting the indication to the user and asking for feedback. The feedback may be a yes/no answer, a grade for the indication, or other feedback. In another example, the indication may be verified through machine learning based on subsequently observed actions. If the determination at 440 is that the indication has not been verified, then method 400 may, at 445, selectively update an affinity hypothesis based on feedback from the user concerning the indication or selectively updating a strength hypothesis based on feedback from the user concerning the confidence level. Updating a hypothesis may include changing weights, changing operations, identifying an observed signal to drop from a calculation, identifying an observed signal to add to a calculation, or other action.

Method 400 may also include, at 450, making a determination about whether the confidence level is to be adapted. The confidence level may be adapted based, for example, on circumstances that exist at the time the recommendation is to be made. If the determination at 450 is no, then processing continues at 460. But if the determination at 450 is yes, then processing continues at 455, where the confidence may be adapted. Adapting the confidence at 455 may include changing the confidence level based on a recency model that accounts for how recently the user has interacted with the item. For example, the confidence level may be increased for more recent interactions and decreased for less recent interactions. The confidence may be changed using a linear function, an exponential function, an irregular function, or in other ways. Adapting the confidence at 455 may also include changing the confidence level based on a time model that accounts for a time at which the user interacted with the item. For example, if the observed signals were acquired during a specific time period (e.g., weekend), and the recommendation is about to be made on a weekend, then the confidence level may be increased. But if the observed signals were acquired during the weekend and the recommendation is about to be made on a Wednesday, then the confidence level may be reduced. In one embodiment, adapting the confidence at 455 may include changing the confidence level based on an environment model that accounts for a location of the user, a device available to the user, or an activity in which the user is engaged. A user may be interested in different things based on where they are. Therefore, the confidence level may be changed based on whether the recommendation may be made to a user who is known to be at home, at work, in transit, out-of-town, or in other locations. A user may choose whether to provide this type of personal information or to make this type of information available. If the user decides to provide this information, the information may be used to adapt the confidence and then discarded. The confidence level may also be changed based on the type of device being used. For example, a user may have different preferences or even interests based on whether they are using a game console, a computer, a tablet, a laptop computer, a smart phone, or other type of device. If the user decides to provide or share this type of information, the information may be used to adapt the confidence and then discarded. Additionally, the confidence level may be adapted based, for example, on an event that may be occurring or imminent. For example, a user may have different interests or preferences during the Super Bowl, while commuting, while playing a certain game, while the kids are in school, or while the kids are out of school. Once again, a user may decide whether to volunteer this type of information that may be used and discarded.

While FIGS. 3 and 4 illustrates various actions occurring in serial, it is to be appreciated that various actions illustrated in FIGS. 3 and 4 could occur substantially in parallel. By way of illustration, a first process could acquire signals, a second process could compute affinity values, a third process could compute confidence values, a fourth process could generate predicted relationships using matrix factorization, and a fifth process could make recommendations. While five processes are described, it is to be appreciated that a greater or lesser number of processes could be employed and that lightweight processes, regular processes, threads, and other approaches could be employed.

In one example, a method may be implemented as computer executable instructions. Thus, in one example, a computer-readable storage medium may store computer executable instructions that if executed by a machine (e.g., computer) cause the machine to perform methods described or claimed herein including methods 300 or 400. While executable instructions associated with the above methods are described as being stored on a computer-readable storage medium, it is to be appreciated that executable instructions associated with other example methods described or claimed herein may also be stored on a computer-readable storage medium. In different embodiments the example methods described herein may be triggered in different ways. In one embodiment, a method may be triggered manually by a user. In another example, a method may be triggered automatically.

In one embodiment, a computer-readable storage medium may store computer-executable instructions that when executed by a computer control the computer to perform a method. The method may include producing a single indication concerning a relationship between a user and an item. The single indication identifies whether the user likes the item and the degree to which the user likes the item. The single indication is independent of user signals processed to compute the single indication. The method may include storing the single indication in a data structure (e.g., matrix). Vectors may be produced from the data in the data structure. The vectors will be independent of the signals used to compute the single indication. The method may also include providing a recommendation to the user concerning another item for which a single indication is stored in the matrix. The recommendation may be based on matrix factorization of vectors produced from data stored in the matrix.

“Computer-readable storage medium”, as used herein, refers to a medium that stores instructions or data. “Computer-readable storage medium” does not refer to propagated signals, per se. A computer-readable storage medium may take forms, including, but not limited to, non-volatile media, and volatile media. Non-volatile media may include, for example, optical disks, magnetic disks, tapes, flash memory, ROM, and other media. Volatile media may include, for example, semiconductor memories, dynamic memory (e.g., dynamic random access memory (DRAM), synchronous dynamic random access memory (SDRAM), double data rate synchronous dynamic random-access memory (DDR SDRAM), etc.), and other media. Common forms of a computer-readable storage medium may include, but are not limited to, a floppy disk, a flexible disk, a hard disk, a magnetic tape, other magnetic medium, a compact disk (CD), other optical medium, a random access memory (RAM), a read only memory (ROM), a memory chip or card, a memory stick, and other media from which a computer, a processor or other electronic device can read.

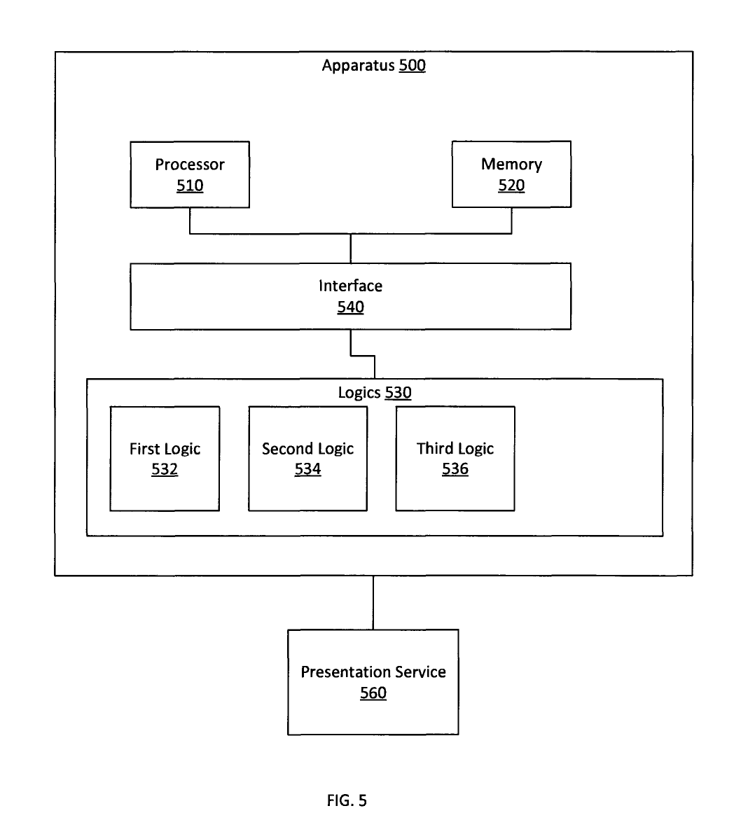

FIG. 5 illustrates an apparatus 500 that includes a processor 510, a memory 520, a set 530 of logics, and an interface 540 that connects the processor 510, the memory 520, and the set 530 of logics. The processor 510 may be, for example, a microprocessor in a computer, a specially designed circuit, a field-programmable gate array (FPGA), an application specific integrated circuit (ASIC), a processor in a mobile device, a system-on-a-chip, a dual or quad processor, or other computer hardware. The set 530 of logics may be configured to use a loosely coupled approach for producing a recommendation that includes predicting a user:item relationship from signal independent vectors formed from a data structure that is populated with data derived from user signals. Apparatus 500 may be, for example, a computer, a laptop computer, a tablet computer, a personal electronic device, a smart phone, a system-on-a-chip (SoC), or other device that can access and process data.

In one embodiment, the apparatus 500 may be a general purpose computer that has been transformed into a special purpose computer through the inclusion of the set 530 of logics. Apparatus 500 may interact with other apparatus, processes, and services through, for example, a computer network.

The set 530 of logics may include a first logic 532 that is configured to produce a first electronic data that describes a relationship between a first user and a first item. The first electronic data may include a user identifier that identifies the first user, an item identifier that identifies the first item, an affinity value that identifies whether the first user likes the first item, and a confidence level associated with the affinity value. The user identifier may be, for example, a user name, a user number, a link associated with the user, or other information. The item identifier may be, for example, an item name, an item number, a link associated with the item, or other information. In one example, the first logic 532 computes the affinity value and the confidence level as a function of observed data about an interaction between the first user and the first item.

The observed data may include explicit signals or implicit signals. The explicit signals may include, for example, a rating of the first item by the first user, a score of the first item by the first user, or a critique of the first item by the first user. The implicit signals may include, for example, an amount of time the first user has used the first item, a number of times the first user has used the first item, whether the first user has used a search engine to search for the first item, how many times the first user has used a search engine to search for the first item, whether the first user has acquired (e.g., purchased, borrowed, rented) the first item, whether the first user has posted information about the first item to a social media site, or whether the first user has recommended the first item. Other implicit or explicit signals may be employed. A hypothesis for computing the affinity value or confidence level may assign different weights to different signals, may assign different operations to different signals, and may include different subsets of the available signals. Thus, in one example, the first logic 532 may be configured to produce the first electronic data from less than all the observed data. In different examples, the first logic 532 may be configured to compute the affinity value and the confidence level using a function that is specific to the first user, using a function that is specific to the first item, using a function that is specific to the first user and first item, or other functions.

The set 530 of logics may also include a second logic 534 that is configured to store the first electronic data in a data structure that stores relationships between users and items according to a strength based model. The data structure may be, for example, a matrix. The relationships may concern affinity values and confidence levels for affinity values. Since the relationships are built from affinity values and confidence levels that do not include the signals from which they were computed, the relationships are therefore independent of the observed data from which the affinity value and confidence level were computed. Having the relationships be independent from the observed signals facilitates decoupling the signal derivation from the relationship prediction which in turn facilitates insulating the two parts of the system from changes that are local to a single part of the system.

In one example, the second logic 534 may be configured to verify the first electronic data before storing the first electronic data in the data structure. Verifying the first electronic data may include receiving feedback from a user about the first electronic data. The feedback may cause the electronic data to be calculated in different ways. For example, weights may be changed, signals may be added to or dropped from a calculation, operations (e.g., addition, multiplication) may be changed, or other actions may be taken. Thus, in one example, the first logic 532 may be configured to change how the affinity value is computed based on feedback about the affinity value from the first user or to change how the confidence level is computed based on feedback about the confidence level from the first user.

The set 530 of logics may also include a third logic 536 that is configured to produce the recommendation as a function of data stored in the data structure. In one example, the recommendation depends on a predicted affinity value for a candidate user for a candidate item. The predicted affinity value may be computed as a function of one or more relationships stored in the data structure. Thus, the recommendation for an item may be a function of relationships between the user and other items, may be a function of relationships between the item and other users, or may be a function of other relationships.

In one example, the third logic 536 may be configured to produce a plurality of vectors from the data stored in the data structure and to compute the predicted affinity value by performing matrix factorization on two or more of the plurality of vectors. Since the vectors are produced from data in the matrix, and since the matrix stores data that is independent of the observed signals, a member of the plurality of vectors has elements that are independent of the observed data. This facilitates localizing changes needed when either the model or the logic used to compute values changes.

In different embodiments, some processing may be performed on the apparatus 500 and some processing may be performed by an external service or apparatus. Thus, in one embodiment, apparatus 500 may also include a communication circuit that is configured to communicate with an external source. In one embodiment, the third logic 536 may interact with a presentation service 560 to facilitate displaying data using different presentations for different devices. For example, information describing items that are recommended to a user may be presented.

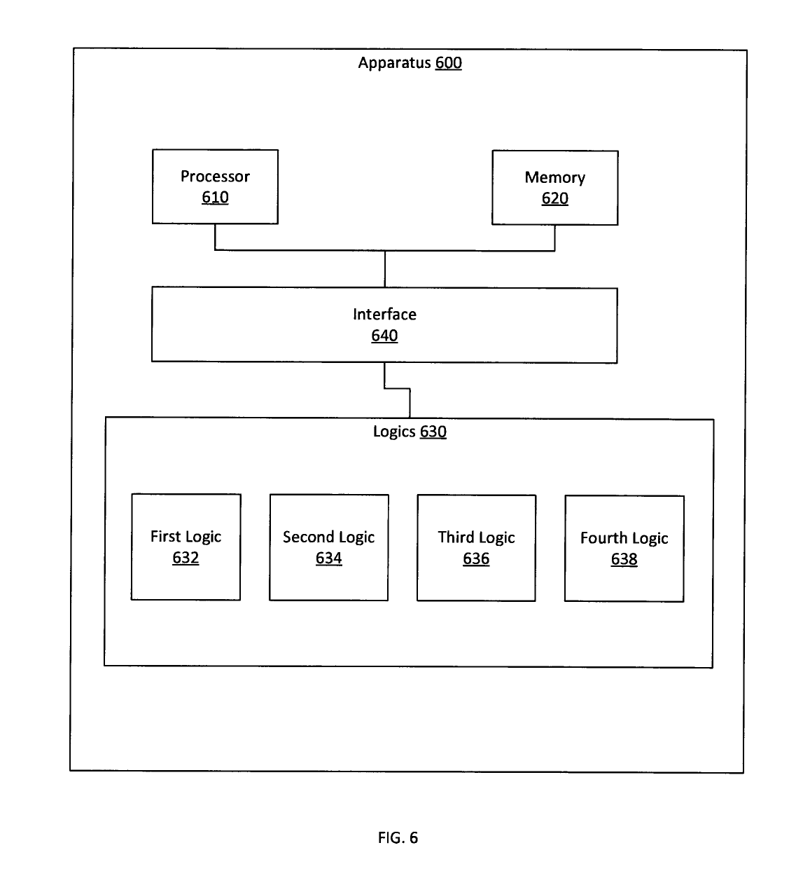

FIG. 6 illustrates an apparatus 600 that is similar to apparatus 500 (FIG. 5). For example, apparatus 600 includes a processor 610, a memory 620, a set of logics 630 (e.g., 632, 634, 636) that correspond to the set of logics 530 (FIG. 5) and an interface 640. However, apparatus 600 includes an additional fourth logic 638. The fourth logic 638 may be configured to perform additional processing.

For example, fourth logic 638 may be configured to manipulate the confidence level for an affinity value as a function of an attribute not used to calculate the affinity value or confidence level. The attribute may be, for example, a time at which the first user interacted with the first item. Interacting with the item may include purchasing the item, using the item, commenting on the item, rating the item, returning the item, selling the item, or other actions. Different interactions may exist for different items. For example a user may have a first set of interactions with a video game, a second set of interactions with a book, and a third set of interactions with an article of clothing. The attribute may also be, for example, a location at which the first user interacted with the first item. The location may include a geographic location (e.g., United States, Canada, England) or a logical location (e.g., home, work). The attribute may also be, for example, an activity in progress when the first user interacted with the first item. The activity may be, for example, gaming, viewing a movie, reading a book, browsing, working, or other activity. The attribute may also include, for example, how recently the first user interacted with the first item. More recent interactions may be factored more heavily and less recent interactions may be factored less heavily. The attribute may also concern the user to whom a recommendation may be provided. Therefore the attribute may include, for example, a time at which the candidate user may interact with the candidate item, a location at which the candidate user may interact with the candidate item, or an activity likely to be in progress when the candidate user interacts with the candidate item.

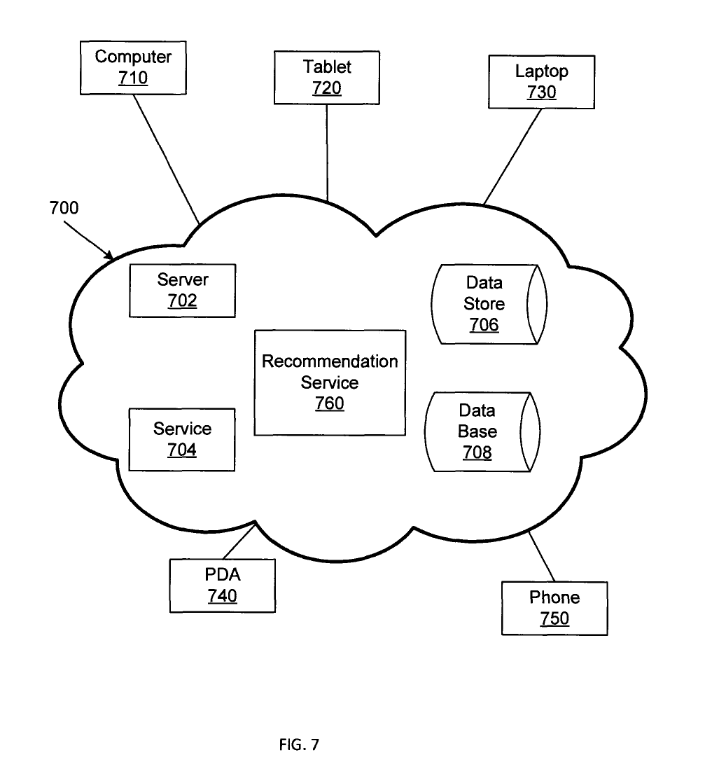

FIG. 7 illustrates an example cloud operating environment 700. A cloud operating environment 700 supports delivering computing, processing, storage, data management, applications, and other functionality as an abstract service rather than as a standalone product. Services may be provided by virtual servers that may be implemented as one or more processes on one or more computing devices. In some embodiments, processes may migrate between servers without disrupting the cloud service. In the cloud, shared resources (e.g., computing, storage) may be provided to computers including servers, clients, and mobile devices over a network. Different networks (e.g., Ethernet, Wi-Fi, 802.x, cellular) may be used to access cloud services. Users interacting with the cloud may not need to know the particulars (e.g., location, name, server, database) of a device that is actually providing the service (e.g., computing, storage). Users may access cloud services via, for example, a web browser, a thin client, a mobile application, or in other ways.

FIG. 7 illustrates an example recommendation service 760 residing in the cloud. The recommendation service 760 may rely on a server 702 or service 704 to perform processing and may rely on a data store 706 or database 708 to store data. While a single server 702, a single service 704, a single data store 706, and a single database 708 are illustrated, multiple instances of servers, services, data stores, and databases may reside in the cloud and may, therefore, be used by the recommendation service 760.

FIG. 7 illustrates various devices accessing the recommendation service 760 in the cloud. The devices include a computer 710, a tablet 720, a laptop computer 730, a personal digital assistant 740, and a mobile device (e.g., cellular phone, satellite phone, wearable computing device) 750. The recommendation service 760 may produce a recommendation for a user concerning a potential acquisition (e.g., purchase, rental, borrowing) using a signal derivation process that is loosely coupled to a relationship predicting process.

It is possible that different users at different locations using different devices may access the recommendation service 760 through different networks or interfaces. In one example, the recommendation service 760 may be accessed by a mobile device 750. In another example, portions of recommendation service 760 may reside on a mobile device 750.

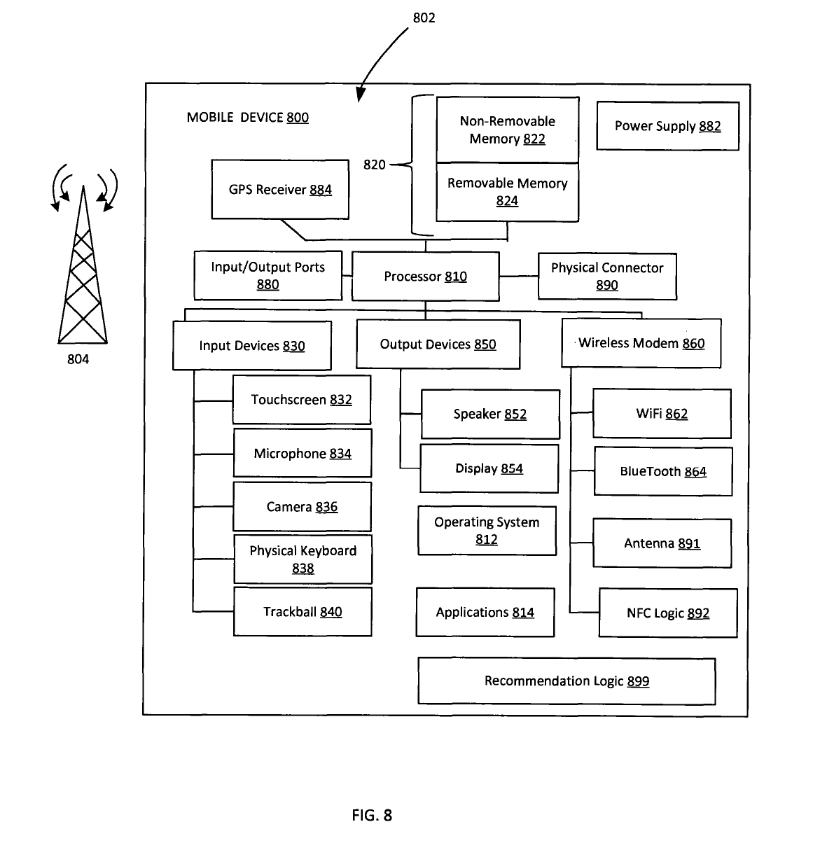

FIG. 8 is a system diagram depicting an exemplary mobile device 800 that includes a variety of optional hardware and software components, shown generally at 802. Components 802 in the mobile device 800 can communicate with other components, although not all connections are shown for ease of illustration. The mobile device 800 may be a variety of computing devices (e.g., cell phone, smartphone, handheld computer, Personal Digital Assistant (PDA), wearable computing device, etc.) and may allow wireless two-way communications with one or more mobile communications networks 804, such as a cellular or satellite networks.

Mobile device 800 can include a controller or processor 810 (e.g., signal processor, microprocessor, ASIC, or other control and processing logic circuitry) for performing tasks including signal coding, data processing, input/output processing, power control, or other functions. An operating system 812 can control the allocation and usage of the components 802 and support application programs 814. The application programs 814 can include mobile computing applications (e.g., email applications, calendars, contact managers, web browsers, messaging applications), video games, recommendation applications, or other computing applications.

Mobile device 800 can include memory 820. Memory 820 can include non-removable memory 822 or removable memory 824. The non-removable memory 822 can include random access memory (RAM), read only memory (ROM), flash memory, a hard disk, or other memory storage technologies. The removable memory 824 can include flash memory or a Subscriber Identity Module (SIM) card, which is well known in GSM communication systems, or other memory storage technologies, such as “smart cards.” The memory 820 can be used for storing data or code for running the operating system 812 and the applications 814. Example data can include implicit signals, explicit signals, single indications, vectors, or recommendations. The memory 820 can be used to store a subscriber identifier, such as an International Mobile Subscriber Identity (IMSI), and an equipment identifier, such as an International Mobile Equipment Identifier (IMEI). The identifiers can be transmitted to a network server to identify users or equipment.

The mobile device 800 can support one or more input devices 830 including, but not limited to, a touchscreen 832, a microphone 834, a camera 836, a physical keyboard 838, or trackball 840. The mobile device 800 may also support output devices 850 including, but not limited to, a speaker 852 and a display 854. Other possible output devices (not shown) can include piezoelectric or other haptic output devices. Some devices can serve more than one input/output function. For example, touchscreen 832 and display 854 can be combined in a single input/output device. The input devices 830 can include a Natural User Interface (NUI). An NUI is an interface technology that enables a user to interact with a device in a “natural” manner, free from artificial constraints imposed by input devices such as mice, keyboards, remote controls, and others. Examples of NUI methods include those relying on speech recognition, touch and stylus recognition, gesture recognition (both on screen and adjacent to the screen), air gestures, head and eye tracking, voice and speech, vision, touch, gestures, and machine intelligence. Other examples of a NUI include motion gesture detection using accelerometers/gyroscopes, facial recognition, three dimensional (3D) displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 812 or applications 814 can include speech-recognition software as part of a voice user interface that allows a user to operate the device 800 via voice commands. Further, the device 800 can include input devices and software that allow for user interaction via a user's spatial gestures, such as detecting and interpreting gestures to provide input to a gaming application.

A wireless modem 860 can be coupled to an antenna 891. In some examples, radio frequency (RF) filters are used and the processor 810 need not select an antenna configuration for a selected frequency band. The wireless modem 860 can support two-way communications between the processor 810 and external devices. The modem 860 is shown generically and can include a cellular modem for communicating with the mobile communication network 804 and/or other radio-based modems (e.g., Bluetooth 864 or Wi-Fi 862). The wireless modem 860 may be configured for communication with one or more cellular networks, such as a Global system for mobile communications (GSM) network for data and voice communications within a single cellular network, between cellular networks, or between the mobile device and a public switched telephone network (PSTN). NFC logic 892 facilitates having near field communications (NFC).

The mobile device 800 may include at least one input/output port 880, a power supply 882, a satellite navigation system receiver 884, such as a Global Positioning System (GPS) receiver, or a physical connector 890, which can be a Universal Serial Bus (USB) port, IEEE 1394 (FireWire) port, RS-232 port, or other port. The illustrated components 802 are not required or all-inclusive, as other components can be deleted or added.

Mobile device 800 may include recommendation logic 899 that is configured to provide a functionality for the mobile device 800. For example, recommendation logic 899 may provide a client for interacting with a service (e.g., service 760, FIG. 7). Portions of the example methods described herein may be performed by recommendation logic 899. Similarly, recommendation logic 899 may implement portions of apparatus described herein.

The following includes definitions of selected terms employed herein. The definitions include various examples or forms of components that fall within the scope of a term and that may be used for implementation. The examples are not intended to be limiting. Both singular and plural forms of terms may be within the definitions.

References to “one embodiment”, “an embodiment”, “one example”, and “an example” indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Data store”, as used herein, refers to a physical or logical entity that can store electronic data. A data store may be, for example, a database, a table, a file, a list, a queue, a heap, a memory, a register, and other physical repository. In different examples, a data store may reside in one logical or physical entity or may be distributed between two or more logical or physical entities. Storing electronic data in a data store causes a physical transformation of the data store.

“Logic”, as used herein, includes but is not limited to hardware, firmware, software in execution on a machine, or combinations of each to perform a function(s) or an action(s), or to cause a function or action from another logic, method, or system. Logic may include a software controlled microprocessor, a discrete logic (e.g., ASIC), an analog circuit, a digital circuit, a programmed logic device, a memory device containing instructions, and other physical devices. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the Applicant intends to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

To the extent that the phrase “one of, A, B, and C” is employed herein, (e.g., a data store configured to store one of, A, B, and C) it is intended to convey the set of possibilities A, B, and C, (e.g., the data store may store only A, only B, or only C). It is not intended to require one of A, one of B, and one of C. When the applicants intend to indicate “at least one of A, at least one of B, and at least one of C”, then the phrasing “at least one of A, at least one of B, and at least one of C” will be employed.

To the extent that the phrase “one or more of, A, B, and C” is employed herein, (e.g., a data store configured to store one or more of, A, B, and C) it is intended to convey the set of possibilities A, B, C, AB, AC, BC, ABC, AA . . . A, BB . . . B, CC . . . C, AA . . . ABB . . . B, AA . . . ACC . . . C, BB . . . BCC . . . C, or AA . . . ABB . . . BCC . . . C (e.g., the data store may store only A, only B, only C, A&B, A&C, B&C, A&B&C, or other combinations thereof including multiple instances of A, B, or C). It is not intended to require one of A, one of B, and one of C. When the applicants intend to indicate “at least one of A, at least one of B, and at least one of C”, then the phrasing “at least one of A, at least one of B, and at least one of C” will be employed.

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus, comprising:
a processor;
a memory;
a set of logics configured to produce a recommendation to a candidate user concerning whether the candidate user will like a candidate item; and
an interface to connect the processor, the memory, and the set of logics;
the set of logics comprising:
a first logic configured to produce a first electronic data that describes a relationship between a first user and a first item,
where the first electronic data includes a user identifier that identifies the first user, an item identifier that identifies the first item, an affinity value that identifies whether the first user likes the first item, and a confidence level associated with the affinity value, and
where the first logic computes the affinity value and the confidence level as a function of observed data about an interaction between the first user and the first item;
a second logic configured to store the first electronic data in a data structure that stores relationships between users and items according to a strength based model, where the relationships concern affinity values and confidence levels for affinity values, and where the relationships are independent of the observed data from which the affinity values and confidence levels were computed; and
a third logic configured to produce the recommendation as a function of data stored in the data structure, where the recommendation depends on a predicted affinity value for the candidate user for the candidate item, and where the predicted affinity value is computed as a function of one or more relationships stored in the data structure.

2. The apparatus of claim 1, where the observed data comprises explicit signals including a rating of the first item by the first user, a score of the first item by the first user, or a critique of the first item by the first user.

3. The apparatus of claim 1, where the observed data comprises implicit signals including an amount of time the first user has used the first item, a number of times the first user has used the first item, whether the first user has used a search engine to search for the first item, how many times the first user has used a search engine to search for the first item, whether the first user has purchased the first item, how many times the first user has purchased the first item, whether the first user has rented the first item, how many times the first user has rented the first item, whether the first user has borrowed the first item, how many times the first user has borrowed the first item, whether the first user has posted information about the first item to a social media site, whether the first user has recommended the first item, or to whom the first user has recommended the first item.

4. The apparatus of claim 1, the first logic being configured to produce the first electronic data from less than all the observed data.

5. The apparatus of claim 1, the first logic being configured to compute the affinity value and the confidence level using a function specific to the first user.

6. The apparatus of claim 1, the first logic being configured to compute the affinity value and the confidence level using a function specific to the first item.

7. The apparatus of claim 1, the first logic being configured to compute the affinity value and the confidence level using a function specific to the first user and the first item.

8. The apparatus of claim 1, the second logic being configured to verify the first electronic data with the first user before storing the first electronic data in the data structure.

9. The apparatus of claim 8, the first logic being configured to change how the affinity value is computed based on feedback about the affinity value from the first user or to change how the confidence level is computed based on feedback about the confidence level from the first user.

10. The apparatus of claim 1, the third logic being configured to produce a plurality of vectors from the data stored in the data structure and to compute the predicted affinity value by performing matrix factorization on two or more of the plurality of vectors, where a member of the plurality of vectors has elements that are independent of the observed data.

11. The apparatus of claim 1, comprising a fourth logic configured to manipulate the confidence level for an affinity value as a function of an attribute not used to calculate the affinity value or confidence level.

12. The apparatus of claim 11, the attribute being a time at which the first user interacted with the first item, a location at which the first user interacted with the first item, an activity in progress when the first user interacted with the first item, how recently the first user interacted with the first item, a time at which the candidate user may interact with the candidate item, a location at which the candidate user may interact with the candidate item, or an activity likely to be in progress when the candidate user interacts with the candidate item.

13. A method, comprising:
accessing a data store that stores signals acquired about a user interaction with an item;
computing an indication of whether the user likes the item from the signals, where the indication is independent of the signals and where the indication is computed as a function of one or more affinity hypotheses specific to the user or item;
computing a confidence level for the indication from the signals, where the confidence level is independent of the signals and where the confidence level is computed as function of one or more strength hypotheses specific to the user or item;
storing the indication and confidence level in a strength based model;
computing a predicted relationship between the user and a second different item, where the predicted relationship is computed from a set of indicators and confidence levels stored in the strength based model, and
selectively providing to the user an electronic data that includes a recommendation concerning the second item based, at least in part, on the predicted relationship.

14. The method of claim 13, where the signals include subjective information provided by the user and objective information acquired about the user interaction with the item.

15. The method of claim 13, comprising:
selectively updating the one or more affinity hypotheses based on feedback from the user concerning the indication; and
selectively updating the one or more strength hypotheses based on feedback from the user concerning the confidence level.

16. The method of claim 13, where computing the predicted relationship includes performing matrix factorization on vectors formed from data in the strength based model, where elements of the vectors are independent from the signals.

17. The method of claim 13, comprising changing the confidence level based on a recency model that accounts for how recently the user has interacted with the item.

18. The method of claim 13, comprising changing the confidence level based on a time model that accounts for a time at which the user interacted with the item.

19. The method of claim 13, comprising changing the confidence level based on an environment model that accounts for a location of the user, a device available to the user, or an activity in which the user is engaged.

20. A computer-readable storage medium storing computer-executable instructions that when executed by a computer control the computer to perform a method, the method comprising:
producing a single indication concerning a relationship between a user and an item, where the single indication identifies whether the user likes the item and the degree to which the user likes the item, and where the single indication is independent of user signals processed to compute the single indication;
storing the single indication in a matrix; and
providing a recommendation to the user concerning another item for which a single indication is stored in the matrix, where the recommendation is based on matrix factorization of vectors produced from data stored in the matrix.
